(19) United States
(12) Patent Application Publication
(10) Pub. No.: US 2009/0132277 A1
(43) Pub. Date: May 21, 2009

(54) SYSTEM AND METHOD FOR MEDICAL PROCEDURE CODE SCHEDULING

(76) Inventor: Kevin L. Molyneaux, Summerside (CA)

Correspondence Address: Carestream Health, Inc., 150 Verona Street, Rochester, NY, 14608, US

(21) Appl. No.: 12/273,058

(22) Filed: Nov. 18, 2008

Related U.S. Application Data
(60) Provisional application No. 60/988,856, filed on Nov. 19, 2007.

(51) Int. Cl. G06Q 10/00; G06Q 50/00; G06F 17/30

(52) U.S. Cl. 705/2; 705/7; 705/8

(57) ABSTRACT

A method for scheduling procedure codes for a healthcare provider, the method including tracking over time prioritization data for each procedure code of a plurality of procedure codes, selecting a part of a body for which one or more procedure codes of the plurality of procedure codes are desired to be scheduled, providing a prioritized list of procedure codes comprising a group of procedure codes from the plurality of procedure codes which are associated with the selected part of the body, wherein the list of procedure codes is ranked based on statistical analysis of the corresponding prioritization data for each of the procedure codes so that the list of procedure codes is arranged in descending order beginning with a procedure code deemed most likely to be selected, and selecting one or more procedure codes from the list of procedure codes for scheduling.

### CROSS REFERENCE TO RELATED APPLICATIONS

Reference is made to, and priority is claimed from, U.S. Provisional Patent Application No. 60/988,856 entitled “RAPID PROCEDURE CODE SELECTION”, filed on Nov. 19, 2007 in the name of Molyneaux, incorporated herein.

### FIELD OF THE INVENTION

The invention relates generally to the field of medical system, and in particular to medical scheduling systems. More specifically, the invention relates to a system and process for scheduling medical procedure codes for a healthcare facility or system.

### BACKGROUND OF THE INVENTION

In healthcare facilities, such as a hospitals and clinics, for example, when a patient is referred and scheduled for an appointment with a particular department (e.g. radiology, laboratory), there is a need to identify which medical procedure(s) will need to be performed by the medical professional(s) (e.g. a radiologist). Typically, each medical procedure is identified by a corresponding procedure code, with the result being that there are thousands of codes from which a person scheduling the appointment must choose to select the desired/required medical procedure(s).

To make selection of the desired procedure codes easier, conventional scheduling systems typically group procedure codes based on body part or modality type. For example, when scheduling a CT scan for a patient's head with a radiology department, the scheduling system will present the user who is scheduling the appointment (e.g. a scheduler, a doctor) with a list of procedure codes specific to a CT scan and the area of the head. In some cases, however, the list of specific procedure codes is quite long and it is time consuming for the user to find and select the desired procedure codes.

To address this situation, some scheduling systems present the user with a set of one or more pre-selected codes which are to be performed for the specific body part or modality, wherein the one or more pre-selected codes are determined by the system users (i.e. doctors, nurses, schedulers) and configured as part of an initial system set-up. However, a user is often required to perform a time consuming search through the entire list of procedure codes in order to find and schedule one or more procedure codes not included in the set of pre-selected codes. Also, the set of pre-selected codes is static and may become outdated as the types of procedure codes typically selected by the system users changes over time, thereby increasing the likelihood that users will spend time searching for procedure codes not include in the pre-selected set.

While such systems may have achieved certain degrees of success in their particular applications, there is a need to provide an improved procedure code scheduling system for medical facilities.

### SUMMARY OF THE INVENTION

An object of the present invention is to provide a system that makes is easier and less-time consuming for users to schedule procedure codes.

Another object of the present invention is to provide a system user with a prioritized list of procedure codes for given medical procedure which is dynamically adjusted over time based on system use.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

According to one aspect of the invention, there is provided a method for scheduling procedure codes for a healthcare provider which includes, tracking over time, prioritization data for each procedure code of a plurality of procedure codes, and selecting a part of a body for which one or more procedure codes of the plurality of procedure codes are desired to be scheduled. The method further includes providing a prioritized list of procedure codes comprising a group of procedure codes from the plurality of procedure codes which are associated with the selected part of the body, wherein the list of procedure codes is ranked based on statistical analysis of the corresponding prioritization data for each of the procedure codes so that the list of procedure codes is arranged in descending order beginning with a procedure code deemed most likely to be selected, and selecting one or more procedure codes from the list of procedure codes for scheduling.

According to one aspect of the invention, tracking prioritization data includes tracking at total number of times each procedure code has been selected for scheduling. According to one aspect of the invention, tracking prioritization data includes tracking for each user the number of times the user has selected each of the procedure codes. According to one aspect, tracking prioritization data includes tracking for each procedure code a number of days since the procedure code was last scheduled.

According to one aspect, providing a prioritized list includes employing a Bayesian network to perform the statistical analysis.

According to one aspect, selecting a part of a body includes selecting the part of the body via a hot link associated with an image of a body or a body part. According to one aspect, selecting a part of a body includes selecting the part of the body from a list of body parts.

By providing a prioritized list of procedure codes associated with a selected body part from which to select procedure codes for scheduling, a user, such as a nurse, doctor, or scheduler, is able to quickly select and schedule desired procedure codes. Additionally, by tracking prioritization data on an on-going basis, the prioritized list of procedure codes is dynamically adjusted and does not become outdated over time. Furthermore, by tracking prioritization data for each individual user, the prioritized list of procedure codes is able to be tailored to each individual's usage history so as to further lessen the time required to locate and select desired procedure codes for scheduling.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a block diagram generally illustrating a procedure code scheduling system according to one embodiment.

FIG. 2 shows an illustrative example of a graphical user interface for use with a procedure code scheduling system according to one embodiment.

FIG. 3 shows an illustrative example of a graphical user interface for use with a procedure code scheduling system according to one embodiment.

FIG. 4 shows a table illustrating an example of prioritization of procedure codes according to one embodiment.

FIG. 5 shows a diagram illustrating a method of scheduling medical procedure codes according to one embodiment.

### DETAILED DESCRIPTION OF THE INVENTION

The following is a detailed description of the preferred embodiments of the invention, reference being made to the drawings in which the same reference numerals identify the same elements of structure in each of the several figures.

According to embodiments described herein, the present disclosure provides a medical procedure scheduling system which provides a list of procedure codes associated with a particular body part or modality to a user, wherein the list of procedure codes is presented in a prioritized fashion, and wherein the list of procedure codes is prioritized on an on-going basis based on a plurality of prioritization factor or inputs which are tracked by scheduling system.

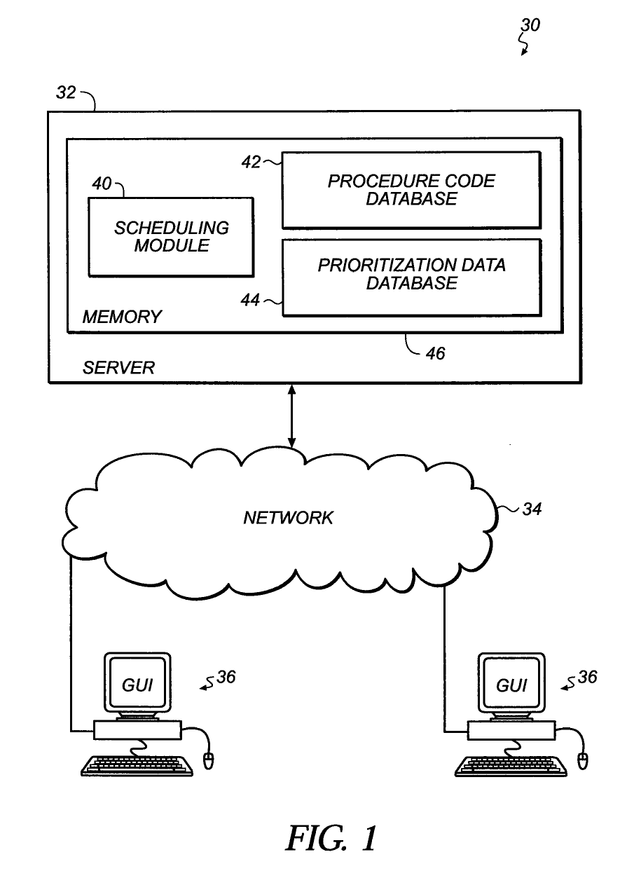

FIG. 1 is a diagram generally illustrating a system 30 for operating a medical procedure scheduling system, according to embodiments described herein, which displays a list of procedure codes in a prioritized fashion from which a user selects to schedule one or more procedure codes to be performed medical professionals of medical facility, such as radiologists of a radiology department of a clinic, for example. According to one embodiment, as illustrated by FIG. 1, system 30 includes a computer 32, such as a server, for example, which is accessible over a network 34 by one or more users via computers 36 (e.g. PCs). Network 34 may include any number of communications networks including the Internet, local area networks, wide array networks, and private networks (e.g. Intranets), for example.

In one embodiment, the medical procedure scheduling system comprises a software application consisting of electronically readable code which is installed and operating on server 32. According to one embodiment, the medical procedure scheduling system comprises a scheduling module 40 comprising a software application for performing desired operations, and application data corresponding to scheduling module 40, such as a procedure code database 42 and a prioritization data database 44, installed in a memory 46 of server 32.

According to one embodiment, procedure code database 42 comprises a plurality of procedure codes, with each code representing a specific medical procedure or specific set of medical procedures to be performed with respect to a body area or a particular portion of the body area. For example, with respect to radiology, a given procedure code indicates to a radiologist the specific images of a specific body part which are to be recorded. The procedure codes of procedure code database 42 may be based on the CPT-4 classification system provided in “Physicians Current Procedural Terminology,” Fourth Edition, by the American Medical Society, for example, or other procedure codes developed and employed by a user of the medical procedure scheduling system.

According to one embodiment, prioritization data database 44 includes data associated with each of the procedure codes of procedure code database 42 and which, as will be described in greater detail below, is employed by scheduling 40 to provide a prioritized list of procedure codes to a user scheduling one or more procedure codes to be performed by personnel of a medical department, such as a radiologist of a radiology department. In one embodiment, as will be described in greater detail below, the prioritization database 44 includes usage data associated with each of the procedure codes of procedure code database 42.

An example of the operation of a medical procedure scheduling system, according to one embodiment, is described below in the context of a radiology department. It is noted, however, that a medical procedure scheduling system, according to embodiments described herein, may be employed to schedule procedures with any number of medical departments (e.g. laboratory services, OB/GYN, cardiology). In operation, when a user (e.g. a scheduler for the radiology department, radiologist) accesses the medical procedure scheduling system, scheduling module 40 displays a graphical user interface (GUI) 50, such as via computer 36, to enable the user to select and schedule procedure codes to be carried out by the radiology department for a patient.

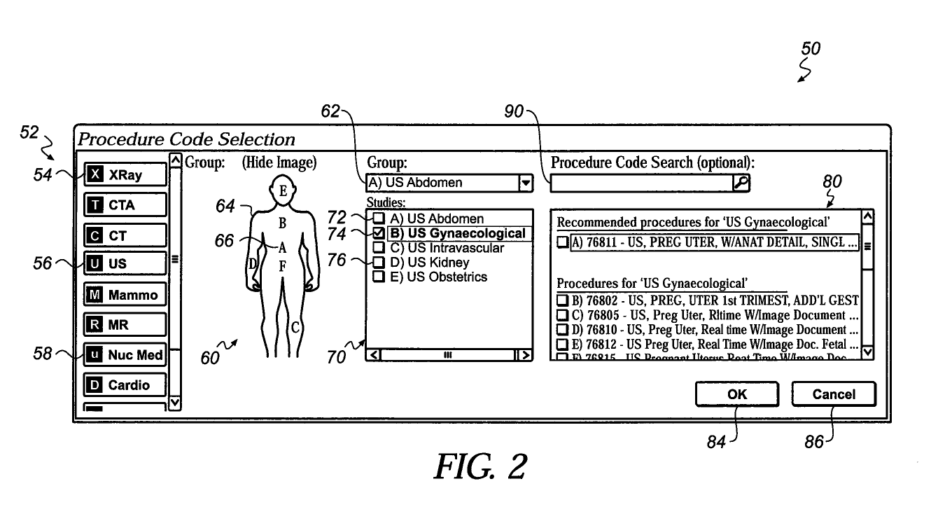

FIG. 2 is a screen capture illustrating one example of GUI 50 (i.e. application screen). According to the embodiment of FIG. 2, GUI 50 includes a group selection menu 52 which enables the user to select a group within the radiological department with which the user wishes to schedule the procedure codes, such as x-ray group 54, ultrasound group 56, and nuclear medicine group 58, for example. After selecting a group from group selection menu 52, a graphic menu 60 displays a graphic from which the user can select a specific area of the body or a specific modality for which the medical procedures are to be performed. According to one embodiment, graphic menu 60 simply comprises a pull-down menu 62 listing various areas of the body or modalities which are pertinent to the group selected from group selection menu 52 and from which the user can select. In one embodiment, graphic menu 60 includes an image 64 of a body or body part which includes hot links, such as hot link 66, from which the user can select a body area or body part (e.g. organ, limb). In one embodiment, as illustrated, graphic menu 60 includes both pull-down menu 62 and image 64.

In the example of FIG. 2, the user is illustrated as having selected the ultrasound group 56, and is additionally illustrated as having selected the abdomen area via either pull-down menu 62 or via hot link “A” 66 of body image 64. As illustrated, if the user selects the desired area or part of the body via image 66, the selected area is automatically displayed in pull-down menu 62. After a body area is selected, a list of “studies” or categories of the selected group which are pertinent to the selected body area are displayed in a study or category menu 70. For example, in the illustrated example, where an ultrasound of the abdomen region has been selected (e.g. ultrasound group 56 and abdomen hot link “A” 66), a list of different categories associated with the abdomen for which an ultrasound may be performed are displayed via category menu 70, such as a general abdomen category 72, a gynecological category 74, and a kidney category 76, for example. In the example of FIG. 2, the user is illustrated as having selecting category “B”, that being gynecological category 74.

After selecting a category via category menu 70, such as by highlighting or selecting the desired category via a “checkbox”, as illustrated by GUI 50, scheduling module 40 provides a ranked or prioritized list of procedure codes associated with the selected category in a recommended procedure code menu 80 from which the user can select one or more desired procedure codes to be performed, in this case, by the radiology department. In one embodiment, procedure codes considered to be associated with a given group or study are configured during a set-up or initialization phase by system users.

According to one embodiment, as will be described in greater detail below, scheduling module 40 ranks or prioritizes the associated list of procedure codes based on statistical analyses of prioritization data which is maintained and updated in prioritization data database 44 on an on-going basis by scheduling module 40, with the procedure codes being displayed in descending order beginning with the procedure code deemed most likely to be the procedure code desired to be selected. According to one embodiment, as will be described in greater detail below, the prioritization data comprises usage data associated with each of the procedure codes.

The user then selects desired procedure codes from the prioritized list of procedure codes in recommended procedure code menu 80, such as by checking or highlighting selection boxes, for example, and submits the selected procedure code to the radiology department for scheduling by clicking on “OK” icon 84, or cancels the order process by clicking on “Cancel” icon 86.

According to one embodiment, if a desired procedure code is not included in procedure code list in recommended procedure code menu 80 scheduling module 40 provides a procedure code search field 90 which enables the user to search remaining codes within procedure code database 42 for the desired procedure code. According to one embodiment, the user enters into search field 90 either a number associated with the procedure code or one or more key words which are descriptive of the associated medical procedure.

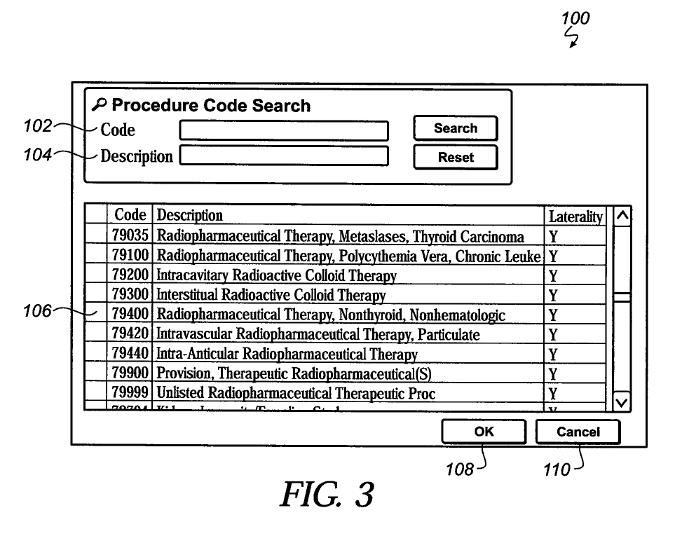

According to one embodiment, upon entering data into procedure search code field 90, a GUI 100, as illustrated by FIG. 3, is displayed to the user by scheduling module 40 via the display of computer 36. According to one embodiment, the user can enter either the actual code number associated with the desired procedure code into a code field 102 and/or one or more key words describing the medical procedure associated with the desired into a description field 104. Based on the information entered into code and description fields 102 and 104, scheduling module 40 provides a list of potential procedure codes in a procedure code menu 106. In one embodiment, the procedure codes listed in menu 106 are prioritized based on a quality of the match between the code number and key word(s) entered in code and description fields 102 and 104 and/or on a statistical analysis of the prioritization data associated with each of the procedure codes (e.g. usage data) maintained in prioritization data database 44. According to one embodiment, if no information is entered into code and description fields 102 and 104, all remaining procedure codes are simply listed in numerical or alphabetical order in procedure code menu 106.

The user then scrolls through the procedure codes listed in procedure code menu 106 and selects the one or more desired procedure codes which were not listed in recommended procedure code menu 80 of GUI 50. Once selected, the additional procedure codes are scheduled with the radiology department or the process is cancelled by respectively selecting “OK” and “Cancel” icons 108 and 110. According to one embodiment, additional procedure codes which are selected via GUI 100 are added to the list of those procedure codes associated with the selected category as listed by recommended procedure code menu 80 of GUI 50 and are included in subsequent scheduling processes whenever the particular category is selected.

As described above, scheduling module 40 prioritizes the list of procedure codes displayed in recommended procedure code menu 80 based on prioritization data stored and updated within prioritization data database 44 by scheduling module 40. According to one embodiment, the prioritization data comprises usage data for each of the procedure codes stored in procedure code database 42. In one embodiment, the usage data for each procedure code includes the number of times all users of the system have selected the procedure code (so-called “system hits”), the number of times the user who is performing the scheduling process has selected the procedure code (so-called “user hits”), and the number of days since the procedure code was last selected. According to one embodiment, the prioritization data is maintained and updated in an on-going basis over time by scheduling module 40 as the procedure codes are selected by users scheduling procedure codes via the medical procedure scheduling system, such as by maintaining a counter for each procedure code, for example.

It is noted that other prioritization data may be employed in addition to the above described usage data. For example, for a medical organization having multiple facilities (e.g. multiple clinics and/or hospitals), in addition to system and user hits, the number of times a procedure code has been selected at a given facility (so-called “facility hits”) may be tracked and employed at the given facility when determining the prioritization of procedure codes.

According to one embodiment, scheduling module 40 employs a ranking algorithm to generate a ranking or prioritization score for each of the procedure codes stored in procedure code database 42 using the prioritization data. Scheduling module 40 then arranges the list of procedure codes in recommended procedure code menu 80 based on the prioritization scores of each of the procedure codes.

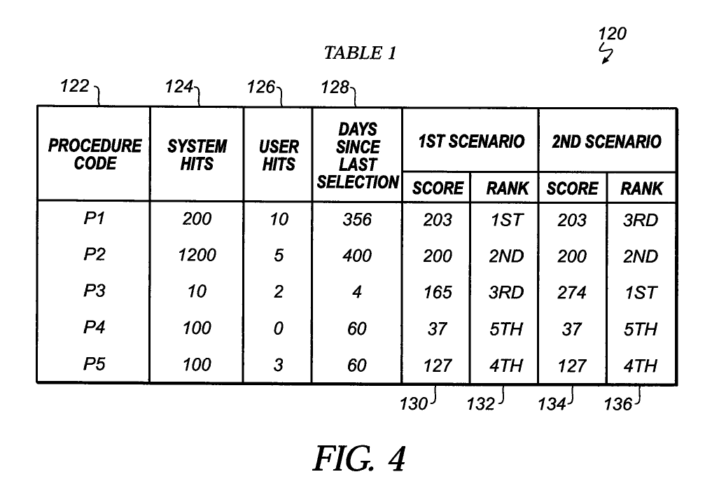

FIG. 4 illustrates examples of the operation of scheduling module 40 based on a plurality of hypothetical procedure codes and associated prioritization data. FIG. 4 is a Table I 120 illustrating a list of five hypothetical procedure codes, P1 through P5, which are to be listed in recommended procedure code menu 80 of GUI 50 for a hypothetical category selected from category menu 70. In Table I, the procedure codes are listed in a first column 122, the number of system and user hits for each procedure code are indicated in second and third columns 124 and 126, and the number of days since each procedure code was last selected is indicated in a fourth column 128.

Equation I below illustrates an example of a ranking algorithm employed by scheduling module 40, according to one embodiment.

Prioritization Score=MAX(LOG(sysHits+1,sysWeight),1)*

MAX(LOG(userHits,userWeight),1)/

MAX(LOG(days,daysWeight),1); Equation I

where:

sysHits=Number of System Hits;

sysWeight=Weighting Value Applied to System Hits Value;

userHits=Number of User Hits;

userWeight=Weighting Value Applied to User Hits Value;

days=Number of Days Since Last Selection; and

daysWeight=Weighting Value Applied to Days Since Last Selection.

It is noted that the MAX function of Equation I is a standard function for taking the highest values of two numbers, and can be found in many standard programming languages (e.g. MS Excel®). Additionally, it is noted that Equation I merely represents an example of one ranking algorithm that may be employed by scheduling module 40. Any number of suitable algorithms may be developed and employed.

According to one embodiment, the weighting values for each of the usage values (i.e. system hits value, user hits value, and days since last selection value) are adjustable within a range of integer values. For example, according to one embodiment, the weighting values for each of the usage values is adjustable between values of 2 and 10, wherein a value of 2 and a value of 10 respectively represent low and high weighting values for the system and user hits values (i.e. 2-low, 10-high), and a value of 2 and a value of 10 respectively represent high and low weighting values for the number of days since last selected value (i.e. 2-high, 10-low).

With reference to Table I 120 of FIG. 4, columns 130 and 132, and columns 134 and 136 illustrated the prioritization score and ranking for procedure codes P1 through P5 generated by the ranking algorithm of Equation I according to different weighting scenarios. According to a first scenario, a weighting value of 10 is used for the system hits value, a weighting value of 2 is used for the user hits value, and a weighting value of 10 is used for the days since last selected value, such that the system hits or system usage is given the highest priority. According to a second scenario, a weighting value of 2 is used for the system hits value, a weighting value of 2 is used for the user hits value, and a weighting value of 2 is used for the days since last selected value, such that the days since last selection factor is given the highest priority. As illustrated by Table 1 120, procedure codes P1 and P3 change ranking or prioritization positions under the first and second weighting scenarios.

By providing a prioritized list of procedure codes associated with a selected body part from which to select procedure codes for scheduling, a user, such as a nurse, doctor, or scheduler, is able to quickly select and schedule desired procedure codes. Additionally, by tracking prioritization data on an on-going basis, the prioritized list of procedure codes is dynamically adjusted and does not become outdated over time. Furthermore, by tracking prioritization data for each individual user, the prioritized list of procedure codes is able to be tailored to each individual's usage history so as to further lessen the time required to locate and select desired procedure codes for scheduling.

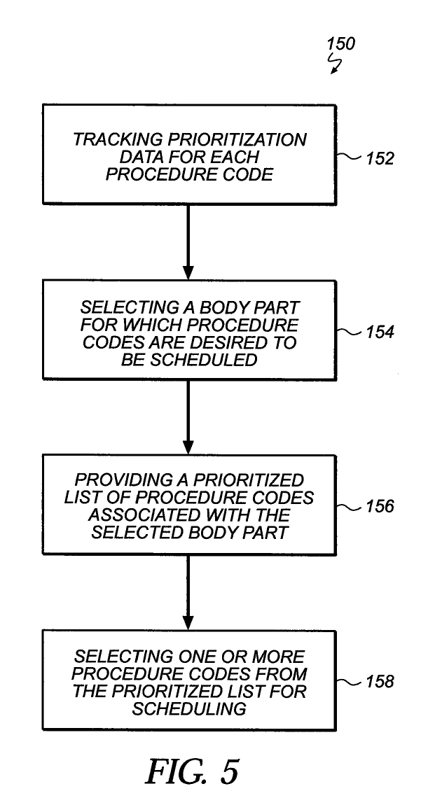

FIG. 5 is a diagram generally illustrating a method 150 for scheduling procedure codes for a medical facility according to one embodiment. At 152, method 152 includes tracking prioritization data for each procedure code of a plurality of procedure codes performed at the medical facility, each procedure code being associated with a particular medical procedure. According to one embodiment, the prioritization data includes usage data for each of the procedure codes, such as described above with respect to FIG. 4. At 154, a user selects a body part or area of the body for which the user desired to schedule procedure codes.

At 156, a prioritized list of recommended procedure codes associated with the selected body part or area is displayed to the user, wherein the list of procedure codes is ranked based on a statistical analysis of the corresponding prioritization data of each procedure code. According to one embodiment, the statistical analysis is based on Bayesian analysis principles. According to one embodiment, prioritized list or recommended procedure codes is arranged in descending order beginning with a procedure code deemed most likely to be selected. According to one embodiment, a prioritization or ranking score is generated for each procedure code, such as described above with respect to Equation I and Table I of FIG. 4. At 158, the user schedules one or more desired procedure codes by selecting them from the prioritized list of recommended procedure codes.

Components of the present invention can be implemented in hardware via a microprocessor, programmable logic, or state machine, in firmware, or in software with a given device. In one aspect, at least a portion of the software programming is web-based and written in HTML and JAVA programming languages, including links to user interfaces, such as a Windows based operating system, and each of the main components may communicate via a network using a communication protocol. For example, the present invention may or may not use a TCP/IP protocol for data transport. Other programming languages and communication protocols suitable for use with the present invention will become apparent to those skilled in the art after reading the present application. For example, the software programming may be written using the .NET programming language or other CIL language (Common Intermediate Language).

Components of the present invention may also reside in software on one or more computer-readable mediums, which is defined herein to include any kind of memory, volatile or non-volatile, such as floppy disks, hard drives, read-only memory (ROM), CD-ROMs, flash memory, and random access memory (RAM).

A computer program product may include one or more storage medium, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the method according to the present invention.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

30 Procedure Code Scheduling System Diagram
32 Computer
34 Network
36 Computer
40 Scheduling Module
42 Procedure Code Database
44 Prioritization Data Database
46 Memory
50 Graphical User Interface
52 Group Selection Menu
54 X-Ray Group Icon
56 Ultrasound Group Icon
58 Nuclear Medicine Group Icon
60 Graphic Menu
62 Pull-Down Menu
64 Body Part Image
66 Hot Link
70 Category Menu
72 General Abdomen Category
74 Gynecological Category
76 Kidney Category
80 Recommended Procedure Code Menu
84 “OK” Icon
86 “Cancel” Icon
90 Procedure Code Search Field
100 Graphical User Interface
102 Procedure Code Number Field
104 Description Entry Field
106 Procedure Code Menu
108 “OK” Icon
110 “Cancel” Icon
120 Table
122 Table Column
124 Table Column
126 Table Column
128 Table Column
130 Table Column
132 Table Column
134 Table Column
136 Table Column
150 Process Diagram
152 Process Block
154 Process Block
156 Process Block
158 Process Block

What is claimed is:

1. A method for scheduling procedure codes for a healthcare provider, the method comprising:
tracking over time prioritization data for each procedure code of a plurality of procedure codes;
selecting a part of a body for which one or more procedure codes of the plurality of procedure codes are desired to be scheduled;
providing a prioritized list of procedure codes comprising a group of procedure codes from the plurality of procedure codes which are associated with the selected part of the body, wherein the list of procedure codes is ranked based on statistical analysis of the corresponding prioritization data for each of the procedure codes so that the list of procedure codes is arranged in descending order beginning with a procedure code deemed most likely to be selected; and
selecting one or more procedure codes from the list of procedure codes for scheduling.

2. The method of claim 1, wherein tracking prioritization data includes tracking at total number of times each procedure code has been selected for scheduling.

3. The method of claim 1, wherein tracking prioritization data includes tracking for each user the number of times the user has selected each of the procedure codes.

4. The method of claim 1, wherein tracking prioritization data includes tracking for each procedure code a number of days since the procedure code was last scheduled.

5. The method of claim 1, wherein providing a prioritized list includes employing a Bayesian network to perform the statistical analysis.

6. The method of claim 1, wherein selecting a part of a body includes selecting the part of the body via a hot link associated with an image of a body or a body part.

7. The method of claim 1, wherein selecting a part of a body includes selecting the part of the body from a list of body parts.

8. A method for scheduling medical procedure codes with a medical department of a medical facility, the method comprising:
providing a graphic illustrating a plurality of selectable parts of a body;
selecting from the graphic a part of the body for which one or more medical procedure codes are desired to be scheduled,
displaying a list of categories associated with the selected part of the body;
selecting a category from the list of categories; and
displaying a list of procedure codes associated with the selected category in a prioritized fashion based on statistical analysis of prioritization data which is maintained in an on-going basis so that the procedure codes are displayed in descending order beginning with a procedure code deemed most likely to be selected.

9. The method of claim 8, further including selecting one or more procedure codes from the list of procedure codes for scheduling with the medical department.

10. The method of claim 9, including updating the prioritization data based on the one or more procedure codes selected for scheduling.

11. The method of claim 8, wherein the graphic comprises a list of body areas.

12. The method of claim 8, wherein the graphic comprises an image of a body

13. The method of claim 8, wherein the body comprises a human body.

14. The method of claim 8, wherein the medical department comprises a radiology department.

15. The method of claim 8, wherein the prioritization data comprises usage data for each of the procedure codes.

16. The method of claim 8, wherein displaying a list of procedure codes includes determining a prioritization score based on the statistical analysis and ranking the procedure codes based on the prioritization scores.

17. A computer readable storage medium storing computer-executable instructions for controlling at least one computer system to perform a method of scheduling procedure codes for a healthcare facility, the method comprising:
tracking over time prioritization data for each procedure code of a plurality of procedure codes;
selecting a part of a body for which one or more procedure codes of the plurality of procedure codes are desired to be scheduled;
providing a prioritized list of procedure codes comprising a group of procedure codes from the plurality of procedure codes which are associated with the selected part of the body, wherein the list of procedure codes is ranked based on statistical analysis of the corresponding prioritization data for each of the procedure codes so that the list of procedure codes are arranged in descending order beginning with a procedure code deemed most likely to be selected; and
selecting one or more procedure codes from the list of procedure codes for scheduling.

18. The method of claim 17, wherein tracking prioritization data includes tracking at total number of times each procedure code has been selected for scheduling.

19. The method of claim 17, wherein tracking prioritization data includes tracking a number of times each procedure code

20. The method of claim 17, wherein tracking prioritization data includes tracking for each procedure code a number of days since the procedure code was last scheduled.

21. The method of claim 17, wherein providing a prioritized list includes employing a Bayesian network to perform the statistical analysis.

22. The method of claim 17, wherein selecting a part of a body includes selecting the part of the body via a hot link associated with an image of a body or a body part.

23. The method of claim 17, wherein selecting a part of a body includes selecting the part of the body from a list of body parts.

24. A server computer comprising:
a procedure code database including a plurality of procedure codes;
a prioritization database including prioritization data for each procedure code of the plurality of procedure codes which is tracked over time; and
a scheduling module configured to provide a prioritized list of procedure codes comprising a group of procedure codes from the plurality of procedure codes which are associated with a selected part of a body, wherein the list of procedure codes is ranked based on statistical analysis of the corresponding prioritization data for each of the procedure codes so that the list of procedure codes is arranged in descending order beginning with a procedure code deemed most likely to be selected.

25. The server computer of claim 24, wherein the prioritization data comprises usage data for each procedure code of the plurality of procedure codes.
